(19) United States
(12) Patent Application Publication
(10) Pub. No.: US 2026/0084563 A1
(43) Pub. Date: Mar. 26, 2026

(54) ELECTRICAL INTERFACE FOR ELECTRICALLY CONNECTING A HAUL TRUCK TO A SHOVEL LOADER

(71) Applicant: Flanders Electric Motor Service, LLC, Evansville, IN (US)

(72) Inventor: Brian Curtis HAVENS, Columbia, SC (US)

(73) Assignee: Flanders Electric Motor Service, LLC, Evansville, IN (US)

(21) Appl. No.: 19/334,708

(22) Filed: Sep. 19, 2025

Related U.S. Application Data
(60) Provisional application No. 63/697,292, filed on Sep. 20, 2024.

(51) Int. Cl. B60L 53/36; B60L 55/00

(52) U.S. Cl. CPC B60L 53/36; B60L 55/00; B60L 2200/36; B60L 2200/40

(57) ABSTRACT

A method including moving a haul truck into an operational loading relationship with a shovel loader. The method also includes establishing an electrical connection between a haul truck bus of the haul truck and a shovel loader bus of the shovel loader. The method also includes transferring electrical power via the electrical connection from the shovel loader to a battery of the haul truck.

### CROSS-REFERENCE TO RELATED APPLICATIONS

This application claims priority to U.S. Provisional Patent Application No. 63/697,292, filed Sep. 20, 2024, the entirety of which is hereby incorporated by reference. This application references U.S. application Ser. No. 18/626,222 and U.S. application Ser. No. 18/626,243, the entireties of which are each hereby incorporated by reference.

### BACKGROUND

Haul trucks and shovel loaders used in heavy mining industries have been moving to either electric power systems or hybrid power systems in order to reduce their carbon footprints, conserve fuel, and decrease ongoing operating expenses. Hybrid haul trucks may continue to run a diesel engine and consume fuel in order to charge a battery. Electric haul trucks may lack the stored electrical energy to operate independently for a desirable amount of time, or may rely on fixed charging or power stations that limit the operational mobility of the electric haul truck. Furthermore, hybrid or electric haul trucks are recharged frequently. Thus, solutions are sought for increasing the electrical energy available to hybrid or electric haul trucks while continuing to decrease reliance on traditional fuels, such as diesel, gasoline, etc.

However, the infrastructure for charging batteries in hybrid or electric haul trucks is expensive and may be located in areas where the haul trucks are not operating. Thus, the haul trucks may reroute to a charging station, though doing so may remove valuable resources (e.g., the haul truck itself) from mine production, thereby decreasing mine productivity, and limiting total fuel savings achieved by using a hybrid or electric haul truck.

### SUMMARY

One or more embodiments provide for a method. The method includes moving a haul truck into an operational loading relationship with a shovel loader. The method also includes establishing an electrical connection between a haul truck bus of the haul truck and a shovel loader bus of the shovel loader. The method also includes transferring electrical power via the electrical connection from the shovel loader to a battery of the haul truck.

One or more embodiments also provide for a system. The system includes a haul truck having a haul truck chassis. The haul truck also includes a drive system connected to the haul truck chassis. The haul truck also includes a battery connected to the drive system. The haul truck also includes a servo connected to the haul truck chassis. The haul truck also includes a charging arm connected to the servo. The charging arm is extendable away from the haul truck chassis via actuation of the servo. The haul truck also includes an electrical bus connected to the charging arm and in electrical connection with the battery. The system also includes a shovel loader, having a shovel loader chassis. The shovel loader also includes a propulsion system connected to the shovel loader chassis. The shovel loader also includes a turntable system connected to the shovel loader chassis. The shovel loader also includes a house connected to the turntable system. The shovel loader also includes a shovel rotatably connected to the turntable system. The shovel loader also includes a charging rail connected to the shovel loader chassis and configured to receive the charging arm of the haul truck. The system also includes an external power source, external to both the haul truck and the shovel loader, electrically connected to the charging rail, when the charging arm is connected to the charging rail, electricity is permitted to flow from the external power source, through the charging rail, through the charging arm, and into the battery of the haul truck.

Other aspects of the one or more embodiments will be apparent from the following description and the appended claims.

### BRIEF DESCRIPTION OF DRAWINGS

FIG. 1 shows a shovel loader filling a haul truck, in accordance with one or more embodiments.

FIG. 2 shows a shovel loader filling a haul truck and providing the haul truck with electrical power, in accordance with one or more embodiments.

FIG. 3 shows a block diagram of the shovel loader of FIG. 1 and FIG. 2, in accordance with one or more embodiments.

FIG. 4 shows a block diagram of the shovel loader charging a haul truck, in accordance with one or more embodiments.

FIG. 5 shows a block diagram of a diesel-electric hybrid haul truck, in accordance with one or more embodiments.

FIG. 6 shows a block diagram of a diesel-electric hybrid haul truck receiving a charge from a shovel loader, in accordance with one or more embodiments.

FIG. 7 shows a block diagram of a mechanical hybrid haul truck, in accordance with one or more embodiments.

FIG. 8 shows a block diagram of a mechanical hybrid haul truck charging from a shovel loader and a haul truck receiving a charge from a shovel loader, in accordance with one or more embodiments.

FIG. 9 shows a flowchart of a method for charging a hybrid or electric haul truck via a shovel loader, in accordance with one or more embodiments.

Like elements in the various figures are denoted by like reference numerals for consistency.

### DETAILED DESCRIPTION

One or more embodiments address the technical problems described above. In particular, one or more embodiments are directed to charging hybrid or electric haul trucks from a shovel loader acting as a power source.

Shovel loaders often have a connection to an electrical grid by way of heavy duty and expensive cables and transformers. Additionally, shovel loaders with batteries may have motor systems that may generate electrical energy as a shovel loader is lowering when loading material into a haul truck, or is turning the house or shovel of the shovel loader back and forth between a haul truck and the material being shoveled.

The generated electrical energy may be stored in a battery and transmitted to other batteries (e.g., a battery in an electric or hybrid haul truck). Thus, a shovel loader may act as a power source, such as when the haul truck is being loaded by the shovel loader. Charging the battery outside of normal haul truck downhill regeneration allows more of the haul truck battery to be used for reducing fuel consumption and greenhouse gas emissions.

However, electrically connecting a shovel loader to a hybrid or electric haul truck while the shovel loader is loading the haul truck is a difficult task. The haul truck is loaded in only a few minutes in typical mining operations. Additionally, manual connection of electrical cables is to be avoided, due to the dangers of handling very high voltage cables (“very high voltage” means voltages that are capable of injuring or killing a person who does not properly handle the electrical wires and systems in question).

One or more embodiments address the above-described difficulties according to multiple techniques. In an embodiment, the shovel loader is provided with a charging rail that extends outwardly from the shovel loader. In turn, a charging arm extends outwardly from the haul truck. The charging rail and charging arm are brought into contact with each other when the truck moves into position for loading by the shovel loader, or in preparation for loading. Electrical power is then transferred from the shovel loader to the haul truck.

An external power source may be provided. The external power source may be connected to the shovel loader via a slip ring. The slip ring permits an electrical charge to be transmitted from a moveable part of the shovel loader to a relatively static part of the shovel loader (i.e., the parts of the shovel loader that do not move back and forth as the shovel is used to load a haul truck). The charging rail may be connected to the slip ring and to a static part of the shovel loader. Thus, electrical power may be routed from the external power source, through the slip ring, through the charging rails, through the charging arm of the haul truck, and into the battery of the haul truck.

In another embodiment, a catenary line may be connected to the shovel loader. The catenary line may extend in multiple directions from the shovel loader. As haul trucks line up in a queue to be loaded by the shovel loader, the haul trucks may connect charging arms to the catenary line. Power then may be transmitted as described above into the haul trucks concurrently.

Still other embodiments are possible, as described below. However, attention is now turned to the figures.

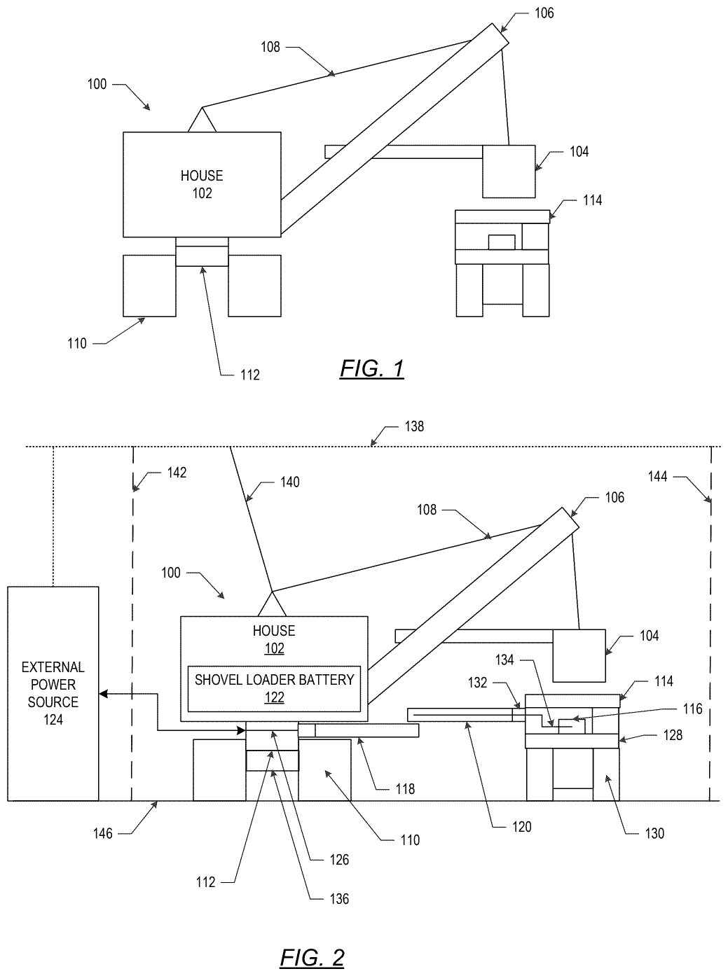

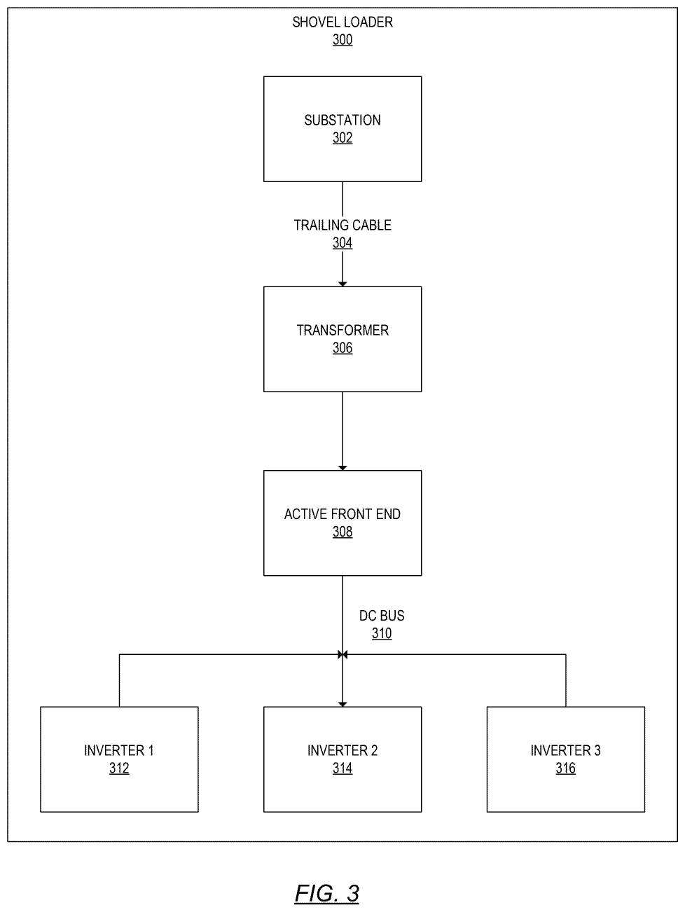

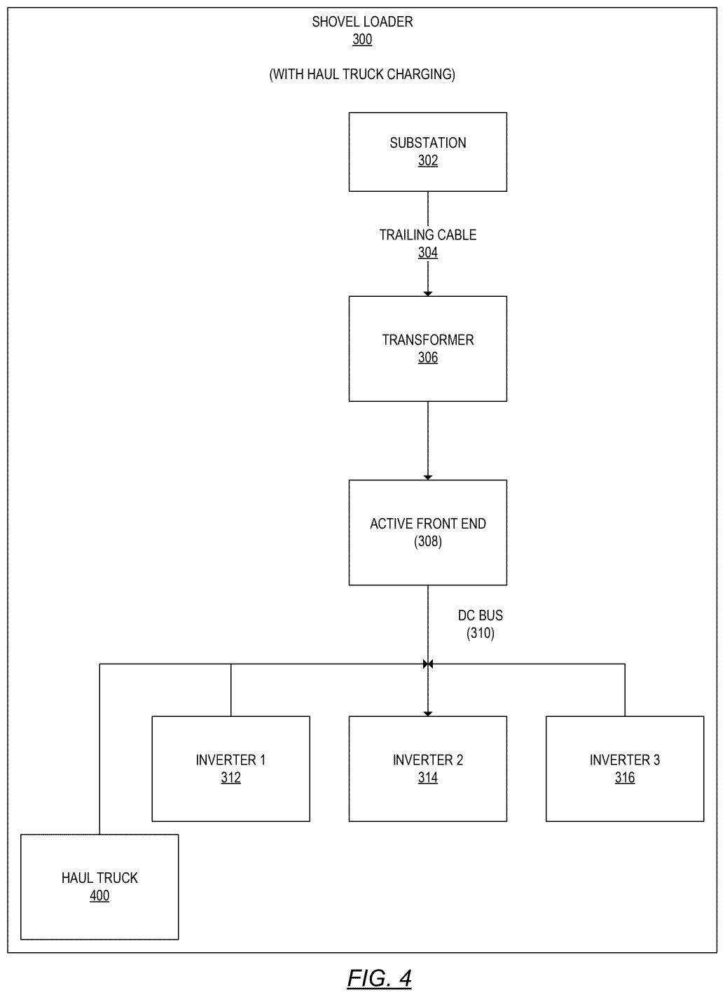

FIG. 1 and FIG. 2 should be considered together. Thus, FIG. 1 and FIG. 2 share common reference numerals referring to common objects. The shovel loader (100) and the haul truck (114) also may be represented by the block diagram shown in FIG. 3 and FIG. 4.

FIG. 1 shows a shovel loader (100) loading material into a haul truck (114) using a shovel (104) portion of the shovel loader. The shovel loader (100) includes a house (102). The house (102) may include a cabin for holding an operator, together with one or more counterweights and other equipment (e.g., the shovel loader battery (122)) shown in FIG. 2). A crane (106) may extend from the house (102). The shovel (104) is connected to the crane (106) at one or more points. In an embodiment, a crane cable (108) may be used to support and move the shovel (104) while the shovel loader (100) is in use. The shovel loader (100) also may include a propulsion system (110) (electric, combustion engine, hybrid, wheels, tracks, etc.) which may be used to move the shovel loader (100) along the surface of the ground. The propulsion system (110) may, in particular, include a turntable system (112). The turntable system (112) may permit the house (102) to rotate about an axis of the turntable system (112) while the remainder of the shovel loader (100) (e.g., the rest of the propulsion system (110)) remains fixed with respect to the ground. The turntable system (112) may include, for example, rotating disks connected to one or more motors, gears, etc., that permit one or more of the house (102) and the crane (106) to rotate relative to other parts of the shovel loader (100).

FIG. 2 shows the shovel loader (100) loading material into a haul truck (114) while concurrently charging a haul truck battery (116) connected to the haul truck (114). In the example of FIG. 2, the haul truck (114) is in a loading operational relationship with the shovel loader (100). Thus, the shovel loader (100) may use the shovel (104) to move material (e.g., from a pile on the ground within reach of the shovel (104)) to the haul truck (114). However, the haul truck (114) also may be in a queue waiting to be loaded (e.g., the haul truck (114) may be located into or out of the page, and thus not necessarily side-by-side with the shovel loader (100)).

In the example shown, a charging rail (118) extends from the shovel loader (100). In an example, the charging rail (118) is on a non-moving part of the shovel loader (100) (i.e., not on the shovel (104), house (102), or crane (106)). The term “non-moving” refers to rotation of the house (102), shovel (104), crane (106), and crane cable (108). The charging rail (118) may translate back and forth with the shovel loader (100) as the propulsion system (110) translates the shovel loader (100) along the ground. While the charging rail (118) may be located on a moving part of the shovel loader (100) (e.g., the house (102) or crane (106)), keeping the charging rail (118) in alignment with the charging arm (120) of the haul truck (114) may be simpler when the charging rail (118) does not move relative to the ground or relative to the haul truck (114). In any case, the charging rail (118) extends outwardly from the shovel loader (100).

Thus, the charging rail (118) may be placed into contact with (i.e., at least electrical communication with, or in physical contact with) a charging arm (120) of the haul truck (114). The charging arm (120) extends outwardly from the haul truck (114). While the charging arm (120) may be placed on any convenient and suitable portion of the charging arm (120), the charging arm (120) may extend outwardly from a side of the haul truck (114) (as opposed to extending from the roof or bottom of the haul truck (114)).

In an embodiment, the haul truck (114) may be connected to gears, actuators, hinges, etc., and combinations thereof, so that the charging arm (120) may lay relatively flat along a side of the haul truck (114) when not in use, but extended into contact relationship with the charging rail (118) when in use. In an embodiment, a second charging arm (substantially similar in design to the charging arm (120)) may be added to an opposite side of the haul truck (114). In this manner, the haul truck (114) may drive up to the shovel loader (100) in any particular direction and still extend the charging arm (120) into a contact relationship with the charging rail (118).

Similarly, the charging rail (118) may be connected to gears, actuators, hinges, etc., and combinations thereof, so that the charging rail (118) may lay relatively flat along a side of the haul truck (114) when not in use, but extended into contact relationship with the charging arm (120) when in use. In an embodiment, a second charging rail (substantially similar in design to the charging rail (118)) may be added to an opposite side of the shovel loader (100). In this manner, the haul truck (114) may drive up to the shovel loader (100) in any particular direction and the shovel loader (100) may still extend the charging rail (118) into a contact relationship with the charging arm (120).

Both the charging rail (118) and the charging arm (120) may include respective electrical busses. Thus, when the charging rail (118) and the charging arm (120) are in contact with each other, electrical current may flow between the charging rail (118) and the charging arm (120).

In an embodiment, the shovel loader (100) may include a shovel loader battery (122). The shovel loader battery (122) may supply energy to the shovel loader (100), and may be connected to the electrical system of the shovel loader (100) (the electrical system includes the charging rail (118); thus, the shovel loader battery (122) may be electrically connected to the charging rail (11822)).

The shovel loader battery (122) may be electrically connected to an external power source (124). The external power source (124) may be one or more power cables that connect to an electrical grid, a generator, a power plant, etc. Thus, the shovel loader battery (122) may draw electrical power from the external power source (124).

In an embodiment, the shovel loader (100) also may include a slip ring (126). The slip ring (126) is a component that permits electrical power to be transferred between moving (i.e., rotating) components. Thus, for example, the shovel loader battery (122) may be disposed in the house (102) of the shovel loader (100), and yet remain in electrical connection with both the charging arm (120) of the haul truck (114) and the external power source (124). Accordingly, in an embodiment, power may flow between the external power source (124), through the slip ring (126), into the shovel loader battery (122), into the charging rail (118), into the charging arm (120), and then into the haul truck battery (116) of the haul truck (114). However, in an embodiment, the haul truck battery (116) may draw electrical energy from the external power source (124) via the charging rail (118) and the charging arm (120) directly, or through the slip ring (126) as an intervening component. Other electrical connection arrangements are contemplated.

Multiple slip rings (e.g., multiple versions of the slip ring (126)) may be disposed inside the base portion of the shovel loader (100). As indicated above, the one or more slip rings may permit an electrical connection with the external power source (124). The slip rings establish an electrical connection with a charging rail (118). The charging rail (118) comes into contact with a charging arm (120) on the haul truck (114). The charging arm (120) may move into connection with the charging rail (118), the charging rail (118) may move into connection with the charging arm (120), or both may move into connection with each other. Other connections are possible, as shown above.

Thus, the components of FIG. 2 may be characterized as a system. The system includes the haul truck (114), the shovel loader (100), and the external power source (124).

The haul truck (114) includes a haul truck chassis (128) and a haul truck drive system (130) connected to the haul truck chassis (128). The haul truck drive system (130) may be electrical or hybrid electric and may be used to propel and power the haul truck drive system (130). The haul truck battery (116) may be connected to the haul truck drive system (130) and thus may be used to drive the haul truck (114) (or to charge the haul truck battery (116) when the motors of the haul truck (114) operate in regenerative mode). The haul truck (114) also includes a servo (132) connected to the haul truck (114) and to the charging arm (120). The charging arm (120) may be moved away from the haul truck chassis (128) via actuation of the servo (132). An electrical bus (134) may be connected to the charging arm (120) and in electrical connection with the haul truck battery (116).

In turn, the shovel loader (100) may characterized as having a shovel loader chassis (136). The propulsion system (110) may be connected to the shovel loader chassis (136). A turntable system (112) may be connected to the shovel loader chassis (136). The house (102) is connected to the shovel loader chassis (136). The shovel (104) is rotatably connected to the turntable system (112) via the crane (106). In other words, while the shovel (104) may or may not rotate relative to the house (102) due to rotation of the crane (106); nevertheless, the shovel (104) is still rotatably connected to the turntable system (112) in that rotation of the turntable system (112) may result in rotation of the shovel (104). In any case, the shovel loader (100) also includes the charging rail (118), which is connected to the shovel loader chassis (136) and configured to receive the charging arm (120) of the haul truck (114).

The system also may include an external power source (124). The external power source (124) is external to both the haul truck (114) and the shovel loader (100). The external power source (124) may be electrically connected to the charging rail (118), as described above. Thus, when the charging arm (120) is connected to the charging rail, electricity may be permitted to flow from the external power source, through the charging rail, through the charging arm (120), and into the haul truck battery (116).

The system described above may include other components. For example, the system shown in FIG. 2 also may include a slip ring (126) rotatably connected to the turntable system (112). The slip ring (126) may be further electrically connected to both the charging rail (118) and the external power source (124).

In one or more embodiments, the system of FIG. 2 also may include a catenary line (138) electrically connected to the external power source (124) and to the electrical system of the shovel loader (100). The electrical system of the shovel loader (100) may include, for example, the turntable system (112), the shovel loader battery (122), the charging rail (118), etc. As shown in FIG. 2, a trail line (140) may connect the catenary line (138) to the house (102) (or other electrical component) of the shovel loader (100). In an embodiment, the catenary line (138) may be supported by one or more towers or poles, such as tower (142) or tower (144) that extend upwardly from the ground (146) (e.g., the surface of the Earth at the location of the shovel loader (100) and the haul truck (114)).

The system of FIG. 2 may be varied. For example, the system also may include multiple haul trucks. If a second (or further) haul truck is present, the second haul truck may have second components, such as those described with respect to the haul truck (114), above. The second (or further) charging arm or arms of the second (or further) haul truck may connect to the catenary line and receive electrical power from the external power source via the shovel loader (100), as described above. Thus, multiple haul trucks may concurrently receive a charge while the haul trucks are in a queue waiting to be loaded. In this manner, the amount of time that a haul truck receives a charge may be increased.

In another variation, a power grid may be disposed in an underground area beneath the shovel loader and the haul truck, or wireless charging pads may be placed on the ground. For example, one or more power cables or charging pads may be disposed on or beneath the ground (146). The power grid, charging pads, and/or cables may be connected to the shovel loader (100), the external power source (124), or both. In this example, at least one of the shovel loader and the haul truck includes a wireless charging receiver for receiving electrical power.

In another example, the power grid may be disposed in an underground area beneath the shovel loader and the haul truck. In this case, the haul truck may further include a second charging arm (120) connectable to the power grid, or may adapt one charging arm that is available for connection to the power grid (i.e., but permitting the charging arm to rotate in three dimensions, or to telescope up and down so that the charging arm may connect to the power grid).

Still other variations are possible. For example, a camera system may be disposed to observe the shovel loader and the haul truck. The camera system may generate an image of the shovel loader and the haul truck. The term “image” refers to either a still photograph or a video. In either case, a control system may be in communication with the haul truck and the camera system.

The control system may be configured to generate a determination that the haul truck is in a position to receive electrical power from the shovel loader. For example, the control system may be a machine learning model programmed to generate the determination by taking the image as input to the machine learning model and generate the determination as output. The control system may be further configured to actuate the servo responsive to the determination from the machine learning model in order to extend the charging arm (120) to the charging rail.

An alternative description of FIG. 1 and FIG. 2 is now presented. Turning to a description of the environment in which one or more embodiments operate, the material that haul trucks move is loaded using a shovel loader. Certain types of electric shovel loaders using active rectifiers, known as active front ends (AFEs). The electric shovel loaders also use alternating current (AC) drives and motors.

One or more embodiments provide for methods and devices for using the AFEs and AC drives and motors to charge a haul truck while the haul truck is being loaded. In this manner, the existing electrical infrastructure already in place for the shovel loader may be reused for charging the hybrid or electric haul truck at the location at which the haul truck already stopped during mining or other production activities.

A problem is encountered with charging hybrid or electric haul trucks while being loaded by a shovel loader. The problem is that hybrid or electric haul trucks spend an average of two minutes under the shovel loader for loading. Current technology does not allow a battery to charge in two minutes.

Thus, one or more embodiments provide for a shovel loader charging network that can be extended using catenary lines (or similar electrical conduits) to allow haul trucks waiting at the shovel loader to be charged as well. Regenerative energy from the shovel loader can be stored in suitable batteries to allow more power flow to haul trucks than the shovel loader would otherwise be able to support. Power can be regenerated at the shovel loader when the shovel loader is moved down or is lowered. Additionally, extra power becomes available when the shovel loader is idling which can then be put into the shovel loader batteries. Additionally, mechanisms such as underground or above ground power grids may be provided that permit haul trucks waiting in line to be loaded by the shovel loader to receive additional electrical power in the haul trucks' batteries.

One or more embodiments may replace the shovel loader with a dragline. A dragline is a larger digging machine that does not directly load haul trucks. However, the basic electrical architecture is similar to shovel loaders in that haul trucks can be connected to the catenary line in the same manner for charging batteries or as a source of power to operate faster without requiring the use of the engine or batteries.

In an embodiment, charging may be performed every time the haul truck is being loaded at the shovel loader, and in some cases while waiting to be loaded. Nevertheless, even limited charging provides 10% to 20% more charge in the battery, such supplemental electrical power still allows the haul truck to save fuel and reduce emissions, relative to no additional charging during mining or other operational activities.

Allowing slightly more time under the shovel loader to charge if no other haul trucks are waiting for the shovel loader can also provide benefits to fuel savings and reduced emissions that exceed the minor time lost during loading. The extra battery charge provided by the shovel loader can be used to provide more power to the haul truck to make up for the lost time while still providing greater fuel savings than without charging.

However, the voltage that haul truck batteries use to charge is different than the voltage that shovel loaders use. Therefore, one or more embodiments provide for AC shovel loaders and draglines that utilize transformers and an AFE to rectify the incoming high AC voltage to a direct current (DC) voltage that is compatible with the DC bus voltage of the hybrid or electric haul truck systems. The hybrid or electric haul truck system contains a DC/DC converter that then adjusts the DC bus voltage to a level that is compatible with the batteries. The DC/DC converter controls the power flow to the batteries and can cut off the charging power once the battery reaches an upper charge threshold without requiring the haul truck to disconnect from the shovel loader.

Another challenge is that the shovel loaders may not have enough spare electrical storage or generation capacity to charge haul trucks. The power systems in shovel loaders are sized to handle the maximum output of the shovel loader, and do not have the spare capacity to charge haul trucks. However, one or more embodiments provide for AC shovel loader and dragline systems that utilize an expandable AFE. Extra capacity may be added to the AFE to allow haul truck charging without requiring major re-work or investments in new systems.

Batteries can be added to the shovel loader to store power when there is extra capacity available. The batteries can then be used to provide more power than the shovel loader is capable of producing when a haul truck is to be charged.

Another challenge is the devices and methods that permit the haul trucks to connect to the shovel loader circuit. The haul trucks back under the shovel loader for loading. One or more embodiments permit the haul trucks to connect to the shovel loader DC bus without a person physically connecting a cable.

In particular, one or more slip rings transfer the DC bus power from the shovel loader house to the propel section of the shovel loader. The DC bus passes through the one or more slip rings to a stationary part of a shovel loader. The electrical rail of the shovel loader may be disposed on a stationary part of the shovel loader. A charging arm on a haul truck may swing or otherwise move and click onto the rail to establish an electrical connection.

A catenary line or shielded section of bus then may be extended from the shovel loader near the propel section. The section does not rotate as the shovel loader house rotates. The haul truck has a robotic charging arm that reaches out and attaches to the catenary line or shielded bus when the operator presses a button. The charging arm can also reach out to a charging rail connected to a rotationally fixed portion of the shovel loader, at least while the base of the shovel loader is not translating relative to the haul truck. For example, the charging arm can be attached to the base of the shovel loader where the treads of the shovel loader are attached.

The haul truck charging arm may hang, or may be built with a servo and gear system, to swing out to a side. Whenever the haul truck stops, the charging arm swings out. The charging arm may have a three dimensional range of motion, extending inwardly, outwardly, upwardly, downwardly, and from side to side, relative to the haul truck or the shovel loader. In an embodiment, an operator on the haul truck or the shovel loader (or both) may maneuver the haul truck or the shovel loader (or both) so that the charging arm comes into electrical contact with the beam. In an embodiment, the haul truck can back up into the connection.

One or more embodiments also provide for a camera system and a control system (e.g., machine learning model such as a neural network or other algorithm) that uses the detected positions of the charging arms to determine how the charging arms should move relative to a stable charging rail on the shovel loader. The control system may actuate servos to move one or both of the charging rail (or rails) and the charging arm to establish the electrical connection.

In an embodiment, the charging rail is not energized until the charging arm is connected via switch or contact. The switch or contact may establish an automatic charging connection upon contact via an electrical circuit.

In an embodiment, there can be multiple rails extending from the shovel loader. There may be multiple charging arms on one or more haul trucks (i.e., one haul truck may have multiple charging arms to connect to multiple beams, or multiple beams may connect to multiple haul trucks). Thus, multiple haul trucks may be charged as the haul trucks wait for the shovel loader to load the haul trucks.

Other connections systems are possible. For example, an overhead electrical rail system may be provided. The haul trucks and the shovel loader may be connected to the rail system (e.g., like a trolley) to connect to multiple haul trucks to the shovel loader as they wait to be loaded.

Another connection system may be a power grid disposed underground or on the surface. The power grid may be configured for wireless charging to charge the haul truck batteries wirelessly as the haul trucks pass over the power grid. The shovel loader charging rail or some other part of the shovel loader, (e.g., a wire or cable) may be connected to the terrestrial power grid.

In an embodiment, the connection need not be wireless. For example, a charging arm on a haul truck can come into contact with the station on the ground. Thus, there may be multiple haul trucks charging at once using the power provided via the shovel loader.

One or more embodiments contemplate combinations of any of the above embodiments. Still other connection systems are possible. Thus, the examples provided above do not necessarily limit one or more embodiments.

FIG. 3 shows a block diagram of the shovel loader of FIG. 1 and FIG. 2, in accordance with one or more embodiments. The shovel loader (300) may be the shovel loader (100) shown in FIG. 1 or FIG. 2. The shovel loader (300) may include a substation (302). The substation (302) may generate or transmit electrical power. A trailing cable (304) may establish an electrical connection with a transformer (306). The transformer (306) transforms the power into a form usable by the shovel loader (300). An active front end (308) (AFE) may rectify the electrical power. A DC bus (310) may convey the rectified current to one or more inverters (e.g., the inverter 1 (312), the inverter 2 (314), and the inverter 3 (316) shown in FIG. 3) used by the motors of the shovel loader (300) to move the shovel loader (300).

FIG. 4 shows a block diagram of the shovel loader (300) of FIG. 3 charging a haul truck, in accordance with one or more embodiments. Thus, FIG. 3 and FIG. 4 share common reference numerals referring to common components. While FIG. 3 and FIG. 4 are substantially similar, a haul truck (400) connects to the DC bus (310) of the shovel loader (300). The connection between the haul truck (400) and the shovel loader (300) may be a direct electrical connection. For example, the charging rail (118) of FIG. 2 may be an extension of the DC bus (310). In this case, the charging rail (118) may directly connect with the charging arm of the haul truck. In an example, the haul truck (400) may include a wireless charging device. In this case, the wireless charging device may wirelessly transmit power from a charging pad or from some other electrical component in communication with the shovel loader (300), an external power source, or a combination thereof. The haul truck (400) also may connect a charging rail to a catenary line or to some other power system.

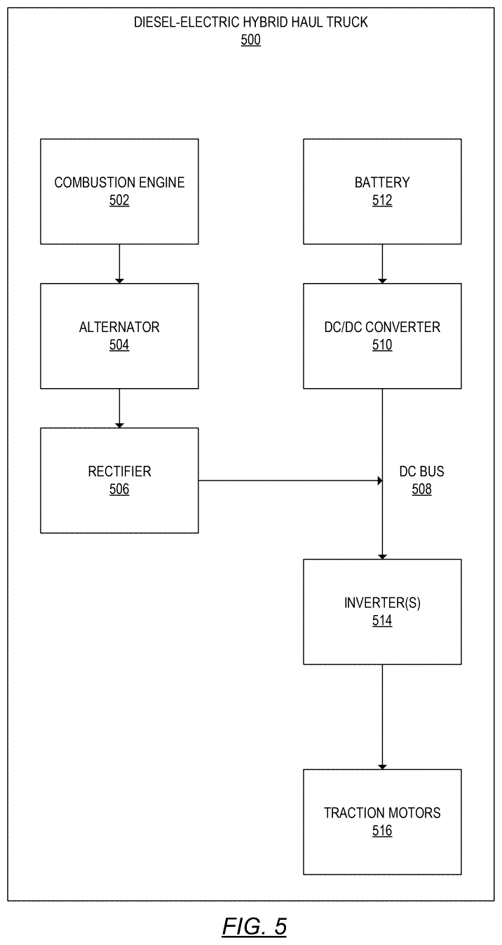

FIG. 5 shows a block diagram of a diesel-electric hybrid haul truck, in accordance with one or more embodiments. The diesel-electric hybrid haul truck (500) is provided with a combustion engine (502) that connects to an alternator (504). The alternator (504) generates electricity. The electricity may be rectified by a rectifier (506), and then provided to a DC bus (508). The DC bus (508) may convert the power with an optional DC/DC converter (510) which then stores the electrical power in a battery (512). The DC bus (508) also may be connected to one or more inverter(s) (514) which converts the electricity into an AC current that may be used to power one or more motors of the haul truck (e.g., traction motors (516)).

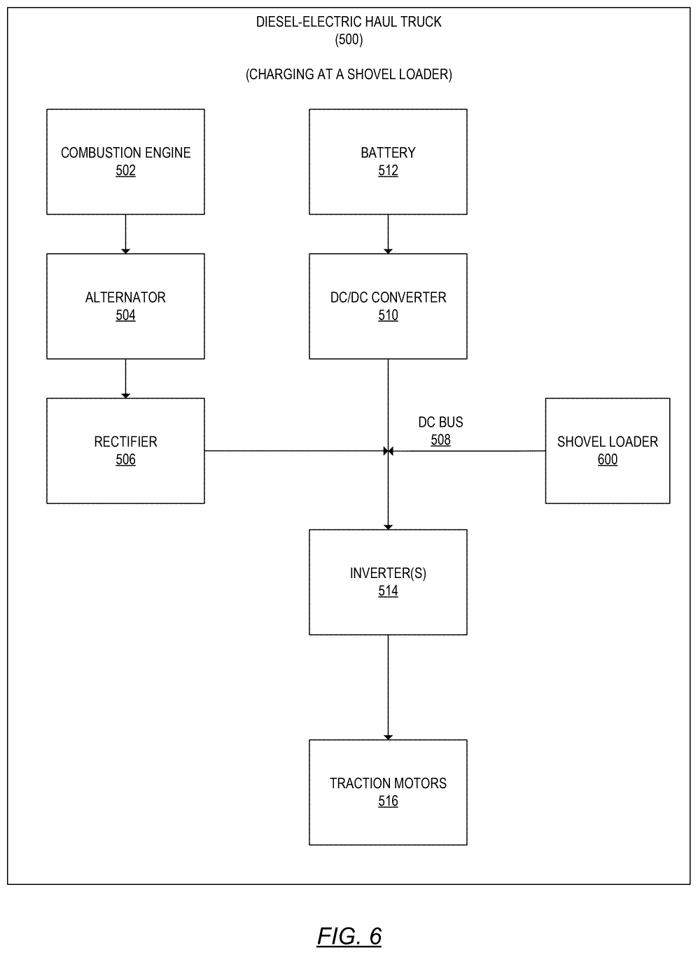

FIG. 6 shows a block diagram of a diesel-electric hybrid haul truck receiving a charge from a shovel loader, in accordance with one or more embodiments. The diesel-electric hybrid haul truck (500) of FIG. 6 is the same as the diesel-electric hybrid haul truck (500) of FIG. 5, and thus FIG. 5 and FIG. 6 share common reference numerals referring to common objects. However, in FIG. 6, the diesel-electric hybrid haul truck (500) is connected to a shovel loader (600) via the DC bus (508). The electrical connection between the shovel loader (600) and the DC bus (508) may be a direct electrical connection. In other words, the corresponding DC busses of the shovel loader (600) and the diesel-electric hybrid haul truck (500) may directly connect to each other.

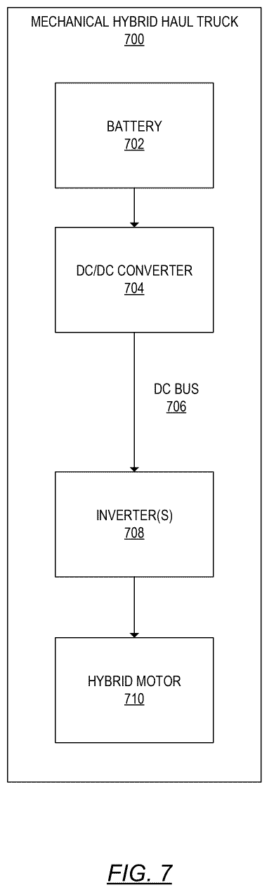

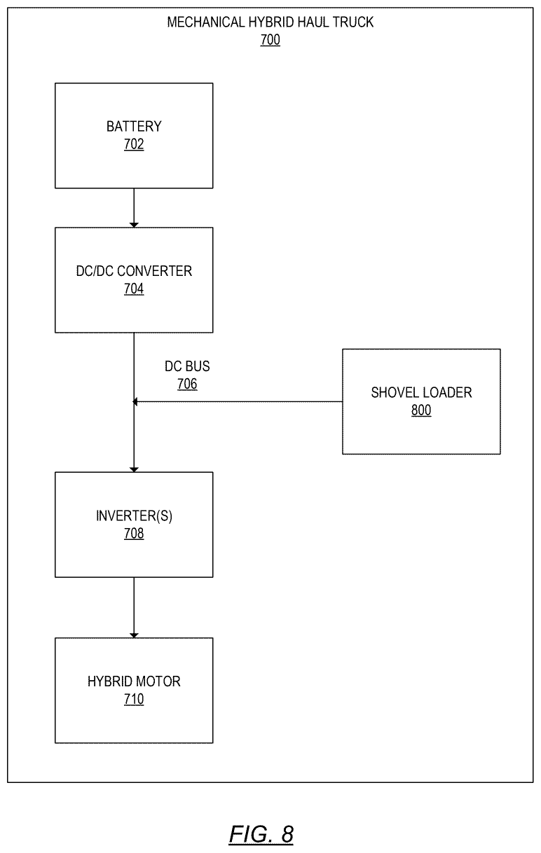

FIG. 7 shows a block diagram of a mechanical hybrid haul truck, in accordance with one or more embodiments. The mechanical hybrid haul truck (700) may be the haul truck shown in U.S. application Ser. No. 18/626,222 or U.S. application Ser. No. 18/626,243 (the entireties of which are hereby incorporated by reference). A battery (702), possibly via a DC/DC converter (704), provides power on a DC bus (706). The power is supplied to one or more inverter(s) (708) which converts the power into an alternating current (AC). The AC provides power to various electrical systems, such as a hybrid motor (710).

FIG. 8 shows a block diagram of a mechanical hybrid haul truck charging from a shovel loader and a haul truck receiving a charge from a shovel loader, in accordance with one or more embodiments. The mechanical hybrid haul truck (700) of FIG. 8 is the same as the mechanical hybrid haul truck (700) of FIG. 7, and thus FIG. 7 and FIG. 8 share common reference numerals referring to common objects. The block diagram of FIG. 8 is similar to the block diagram of FIG. 7, but the mechanical hybrid haul truck (700) is connected to a shovel loader (800) via the DC bus (706). The electrical connection between the shovel loader (800) and the DC bus (706) may be a direct electrical connection. In other words, the corresponding DC busses of the shovel loader (800) and the mechanical hybrid haul truck (700) may directly connect to each other.

While FIG. 1 through FIG. 8 shows a configuration of components, other configurations may be used without departing from the scope of one or more embodiments. For example, various components may be combined to create a single component. As another example, the functionality performed by a single component may be performed by two or more components.

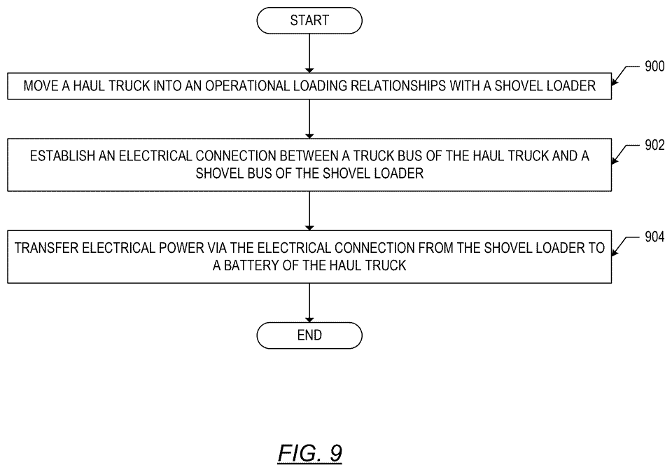

FIG. 9 shows a flowchart of a method for charging a hybrid or electric haul truck via a shovel loader, in accordance with one or more embodiments. The method of FIG. 9 may be performed using the haul truck, shovel loader, and systems described with respect to FIG. 1 through FIG. 8.

Step 900 includes moving a haul truck into an operational loading relationships with a shovel loader. The haul truck may be moved into position as described above. For example, the haul truck may be driven or maneuvered into proximity with the shovel loader such that the shovel loader may load the bed of the haul truck. However, step 900 also may include moving the haul truck into a queue of haul trucks waiting to be loaded. A haul truck in the queue may be considered to be in the operational loading relationship with the shovel loader.

Step 902 includes establishing an electrical connection between a haul truck bus of the haul truck and a shovel loader bus of the shovel loader. The electrical connection may be accomplished as described above. For example, the charging arm of the haul truck may be moved into contact with the charging rail of the shovel loader. The haul truck may move the arm into said contact, or one or both of the charging arms (of the haul truck) or the charging rail (of the shovel loader) may be moved into contact with each other. Step 902 also includes the embodiment of moving the charging arm of the haul truck into electrical contact with a catenary line electrically connected to the shovel loader, or into electrical contact with a power grid (e.g., and underground power grid), also in electrical contact with the shovel loader.

Step 902 may include extending a charging arm from the haul truck to establish a physical contact between the charging arm and a charging rail extending from the shovel loader. The charging arm is in electrical connection with the haul truck bus, and the charging rail is in electrical connection with the shovel loader bus. In this manner, electrical power may flow therebetween, as described in step 904.

In another variation, establishing the electrical connection also may include extending a charging arm from the haul truck to establish an electrical contact between the charging arm and a catenary line connected to the shovel loader. Establishing the electrical connection may be performed prior to moving the haul truck into the operational loading relationship with the shovel loader.

In still another variation, step 902 contemplates moving a second haul truck into a queue including the haul truck and then extending a second charging arm from the second haul truck to establish electrical contact between the second charging arm and the catenary line. In other words, establishing the electrical connection may include establishing multiple electrical contacts among multiple haul trucks.

Step 904 includes transferring electrical power via the electrical connection from the shovel loader to a battery of the haul truck. The transfer of electrical power may be accomplished as described above. For example, the electrical power may be received from an external power source, transmitted to an AC bus of the shovel loader, transmitted to a rectifier to convert the AC current into a DC current, transmitted via a slip ring of the shovel loader, transmitted to the charging rail of the shovel loader, transmitted into the charging arm of the haul truck, then transmitted to a DC bus in the haul truck, and then transmitted finally into the battery of the haul truck. One or more of the connections mentioned above may be omitted, and additional electrical components may be connected to the electrical connections described above.

Transferring electrical power also contemplates transferring electrical power to one or more haul trucks. For example, electrical power may be transferred from the shovel loader to the first or second haul trucks via a catenary line.

The method of FIG. 2 may be varied. For example, the method of FIG. 2 also may include rotating a shovel of the shovel loader and loading the haul truck with the shovel while the charging rail remains stationary. In this case, the method also may include rotating a slip ring connected to the charging rail and to an external power source, as described above.

In another variation, the method of FIG. 9 may include generating, using a motor and by operation of the shovel loader, additional electricity via regenerative energy production. For example, the motor may be used to brake motion of the shovel, the housing, or the shovel loader as a whole. In this case, the motor generates electrical energy. The additional electrical energy generated may be stored in a shovel loader battery of the shovel loader. In an embodiment, transferring electrical power via the electrical connection from the shovel loader to a battery of the haul truck includes transferring the electrical power from the shovel loader battery.

In a related embodiment, the method of FIG. 9 also may include receiving, from an external power source, further electricity. In this case, the method also includes storing the further electricity in the shovel loader battery. The stored energy then may be transferred later to a haul truck according to the techniques described above.

In still another embodiment, the method may include receiving, from an external power source, an alternating current. The method then includes powering at least a portion of the shovel using a first amount of the alternating current. The method, however, also includes rectifying a second amount of the electrical current into a direct current. In this case, transferring the electrical power includes transferring the direct current to the battery of the haul truck, according to the techniques described above.

In a related embodiment, the method then may include converting, by a direct-current-to-direct-current converter connected to the haul truck and prior to transferring the electrical power to the battery of the haul truck, the direct current to a converted direct current compatible for use with the battery of the haul truck. In other words, a DC/DC converter is used to convert one voltage or current of DC electrical energy into another voltage or current of DC electrical energy.

In still another related embodiment, the method may include measuring a charge level of the battery of the haul truck. In this case, the method may include stopping, by the direct-current-to-direct-current converter, transfer of the electrical power while maintaining the electrical connection. For example, a switch may be used to stop the current flow when the battery is full.

In yet another related embodiment, the method may include receiving, from a camera system disposed to observe the shovel loader and the haul truck, an image of the shovel loader and the haul truck. In this case, the method may include generating, using a control system in communication with the haul truck and the camera system, a determination that the haul truck is in a position to receive electrical power from the shovel loader, wherein the determination is generated using the image.

For example, the image may be converted into a vector data structure. A vector is a computer-readable data structure, often in the form of a 1×N table composed of features (e.g., pixel color and brightness ranges) and values (numbers representing the value of pixel color and brightness ranges). The vector data structure may be provided as input to a classification machine learning model or to a neural network. The machine learning model also may be a language model or multi-modal model, in which case the input also may include a prompt. The output of the machine learning model is a prediction whether or not the charging arm of the haul truck may form a connection with the charging rail of the shovel loader.

Then, the method includes extending, responsive to the determination that the haul truck may establish the connection described above, a charging arm from the haul truck to establish a physical contact between the charging arm and a charging rail extending from the shovel loader. Extending may be performed using a control system, as described above. Thus, the charging arm may be placed in electrical connection with the haul truck bus. The charging rail also may be placed in electrical connection with the shovel loader bus.

In an embodiment, the control system may include the machine learning model for generating the determination, as described above. The control system also may include a servo connected to the charging arm and in communication with the machine learning model. In this case, generating may include providing the image as input to the machine learning model and receiving the determination as output from the machine learning model. Additionally, extending may include actuating the servo responsive to the output from the machine learning model.

While the various steps in the flowchart of FIG. 9 are presented and described sequentially, at least some of the steps may be executed in different orders, may be combined or omitted, and at least some of the steps may be executed in parallel. Furthermore, the steps may be performed actively or passively. Still other variations of the method are also possible.

As indicated above, one or more embodiments may include a method. The method includes moving a haul truck into an operational loading relationship with a shovel loader. The method also includes establishing an electrical connection between a haul truck bus of the haul truck and a shovel loader bus of the shovel loader. The method also includes transferring electrical power via the electrical connection from the shovel loader to a battery of the haul truck.

One or more embodiments also provide for a haul truck. The haul truck includes a drive system, a battery connected to the drive system, a servo, and a charging arm connected to the servo. The haul truck also includes an electrical bus connected to the charging arm and in electrical connection with the battery.

The term “about,” when used with respect to a physical property that may be measured, refers to an engineering tolerance anticipated or determined by an engineer or manufacturing technician of ordinary skill in the art. The exact quantified degree of an engineering tolerance depends on the product being produced and the technical property being measured. For example, two angles may be “about congruent” if the values of the two angles are within a first predetermined range of angles for one embodiment, but also may be “about congruent” if the values of the two angles are within a second predetermined range of angles for another embodiment. The ordinary artisan is capable of assessing what is an acceptable engineering tolerance for a particular product, and thus is capable of assessing how to determine the variance of measurement contemplated by the term “about.”

As used herein, the term “connected to” contemplates at least two meanings, unless stated otherwise. In a first meaning, “connected to” means that component A was, at least at some point, separate from component B, but then was later joined to component B in either a fixed or a removably attached arrangement. In a second meaning, “connected to” means that component A could have been integrally formed with component B. Thus, for example, a bottom of a pan is “connected to” a wall of the pan. The term “connected to” may be interpreted as the bottom and the wall being separate components that are snapped together, welded, or are otherwise fixedly or removably attached to each other. However, the bottom and the wall may be deemed “connected” when formed contiguously together as a monocoque body.

In addition, the term “directly connected to” means that component A and component B are connected immediately adjacent to each other. For example, component A and component B may share a common point of contact in at least one area of both components. However, the common point of contact may be a connector (e.g., a bolt, a screw, etc.), in which case it is possible that component A is “directly connected to” component B without a direct contact between the surfaces of component A and component B. However, in any case, if component A and component B are “directly connected to” each other, then no intervening parts, other than possibly a connector, exist between component A and component B.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
moving a haul truck into an operational loading relationship with a shovel loader;
establishing an electrical connection between a haul truck bus of the haul truck and a shovel loader bus of the shovel loader; and
transferring electrical power via the electrical connection from the shovel loader to a battery of the haul truck.

2. The method of claim 1, wherein establishing the electrical connection further comprises:
extending a charging arm from the haul truck to establish a physical contact between the charging arm and a charging rail extending from the shovel loader,
wherein the charging arm is in electrical connection with the haul truck bus, and
wherein the charging rail is in electrical connection with the shovel loader bus.

3. The method of claim 2, further comprising:
rotating a shovel of the shovel loader and loading the haul truck with the shovel while the charging rail remains stationary; and
rotating a slip ring connected to the charging rail and to an external power source.

4. The method of claim 1, wherein establishing the electrical connection further comprises:
extending a charging arm from the haul truck to establish an electrical contact between the charging arm and a catenary line connected to the shovel loader.

5. The method of claim 4, further comprising:
establishing the electrical connection prior to moving the haul truck into the operational loading relationship with the shovel loader.

6. The method of claim 4, further comprising:
moving a second haul truck into a queue including the haul truck;
extending a second charging arm from the second haul truck to establish electrical contact between the second charging arm and the catenary line; and
transferring electrical power from the shovel loader to the second haul truck via the catenary line.

7. The method of claim 1, further comprising:
generating, using a motor and by operation of the shovel loader, additional electricity via regenerative energy production; and
storing the additional electricity in a shovel loader battery of the shovel loader;
wherein transferring electrical power via the electrical connection from the shovel loader to a haul truck battery of the haul truck includes transferring electrical power from the shovel loader battery.

8. The method of claim 7, further comprising:
receiving, from an external power source, further electricity; and
storing the further electricity in the shovel loader battery.

9. The method of claim 1, further comprising:
receiving, from an external power source, an alternating current;
powering at least a portion of the shovel loader using a first amount of the alternating current; and
rectifying a second amount of the alternating current into a direct current,
wherein transferring electrical power comprises transferring the direct current to the battery of the haul truck.

10. The method of claim 9, further comprising:
converting, by a direct-current-to-direct-current converter connected to the haul truck and prior to transferring electrical power to the battery of the haul truck, the direct current to a converted direct current compatible for use with the battery of the haul truck.

11. The method of claim 10, further comprising:
measuring a charge level of the battery of the haul truck; and
stopping, by the direct-current-to-direct-current converter, transfer of electrical power while maintaining the electrical connection.

12. The method of claim 10, further comprising:
receiving, from a camera system disposed to observe the shovel loader and the haul truck, an image of the shovel loader and the haul truck;
generating, using a control system in communication with the haul truck and the camera system, a determination that the haul truck is in a position to receive electrical power from the shovel loader, wherein the determination is generated using the image; and
extending, responsive to the determination and using the control system, a charging arm from the haul truck to establish a physical contact between the charging arm and a charging rail extending from the shovel loader,
wherein the charging arm is in electrical connection with the haul truck bus, and
wherein the charging rail is in electrical connection with the shovel loader bus.

13. The method of claim 12, wherein the control system comprises a machine learning model programmed to perform generating, and a servo connected to the charging arm and in communication with the machine learning model, and wherein:
generating comprises providing the image as input to the machine learning model and receiving the determination as output from the machine learning model; and
extending comprises actuating the servo responsive to the output from the machine learning model.

14. A system comprising:
a haul truck, comprising:
a haul truck chassis,
a drive system connected to the haul truck chassis,
a battery connected to the drive system,
a servo connected to the haul truck chassis,
a charging arm connected to the servo, wherein the charging arm is extendable away from the haul truck chassis via actuation of the servo, and
an electrical bus connected to the charging arm and in electrical connection with the battery; and
a shovel loader, comprising:
a shovel loader chassis,
a propulsion system connected to the shovel loader chassis,
a turntable system connected to the shovel loader chassis,
a house connected to the turntable system,
a shovel rotatably connected to the turntable system, and
a charging rail connected to the shovel loader chassis and configured to receive the charging arm of the haul truck; and
an external power source, external to both the haul truck and the shovel loader, electrically connected to the charging rail, wherein, when the charging arm is connected to the charging rail, electricity is permitted to flow from the external power source, through the charging rail, through the charging arm, and into the battery of the haul truck.

15. The system of claim 14, wherein the shovel loader further comprises:
a slip ring rotatably connected to the turntable system, wherein the slip ring is further electrically connected to both the charging rail and the external power source.

16. The system of claim 14, wherein the shovel loader further comprises:
a catenary line electrically connected to the external power source and an electrical system of the shovel loader.

17. The system of claim 16, further comprising:
a second haul truck, comprising:
a second haul truck chassis,
a second drive system connected to the second haul truck chassis,
a second battery connected to the second drive system,
a second servo connected to the second haul truck chassis,
a second charging arm connected to the second servo, wherein the second charging arm is extendable away from the second haul truck chassis via actuation of the servo, and
a second electrical bus connected to the second charging arm and in electrical connection with the second battery, and
wherein the second charging arm is electrically connected to the catenary line.

18. The system of claim 14, further comprising:
a power grid disposed in an underground area beneath the shovel loader and the haul truck;
wherein at least one of the shovel loader and the haul truck comprises a wireless charging receiver for receiving electrical power.

19. The system of claim 14, further comprising:
a power grid disposed in an underground area beneath the shovel loader and the haul truck;
wherein the haul truck further comprises a second charging arm connectable to the power grid.

20. The system of claim 14, further comprising:
a camera system disposed to observe the shovel loader and the haul truck, and to generate an image of the shovel loader and the haul truck; and
a control system in communication with the haul truck and the camera system, the control system configured to generate a determination that the haul truck is in a position to receive electrical power from the shovel loader, wherein:
the control system comprises a machine learning model programmed to generate the determination by taking the image as input to the machine learning model and generate the determination as output,
the control system is further configured to actuate the servo responsive to the determination from the machine learning model in order to extend the charging arm to the charging rail.
